(19) United States
(12) Patent Application Publication
(10) Pub. No.: US 2025/0140946 A1
(43) Pub. Date: May 1, 2025

(54) BATTERY MODULE AND BATTERY PROTECTION METHOD THEREOF

(71) Applicant: ASUSTeK COMPUTER INC., Taipei City (TW)

(72) Inventors: Chia-Sen Chang, Taipei City (TW); Ying-Yui Wu, Taipei City (TW)

(73) Assignee: ASUSTeK COMPUTER INC., Taipei City (TW)

(21) Appl. No.: 18/915,294

(22) Filed: Oct. 14, 2024

(30) Foreign Application Priority Data
Nov. 1, 2023 (TW) 112141906

(51) Int. Cl. H01M 10/42; G01K 3/00; H01M 10/44; H01M 10/48; H02J 7/00

(52) U.S. Cl. CPC H01M 10/425; G01K 3/005; H01M 10/441; H01M 10/443; H01M 10/482; H01M 10/486; H02J 7/0016; H02J 7/0029; H02J 7/0047; H02J 7/007194; H01M 2010/4271

(57) ABSTRACT

A battery module and a battery protection method thereof are provided. The battery module includes a battery cell pack and a control circuit. The battery cell pack includes a plurality of battery cells connected in series. The control circuit detects an internal temperature of the battery module and determines whether the internal temperature of the battery module is greater than a temperature threshold value. When the internal temperature is greater than the temperature threshold value, the control circuit turns on a self-balancing function.

### CROSS-REFERENCE TO RELATED APPLICATION

This application claims the priority benefit of Taiwan application serial no. 112141906, filed on Nov. 1, 2023. The entirety of the above-mentioned patent application is hereby incorporated by reference herein and made a part of this specification.

### BACKGROUND

### Technical Field

The application relates to a battery module that can avoid a Permanent Fail (PF) state and a battery protection method used therein.

### Description of Related Art

In today's handheld electronic products (for example, notebook computers, mobile phones, digital cameras or tablet computers), batteries play an important role in power supply. The battery has a discharge loop established by a discharge circuit. When there is a voltage imbalance between each battery cell inside the battery, a self-balancing function can be activated and the discharge loop is used to discharge the high-voltage battery cell to a low voltage, thereby achieving the voltage balance of each battery cells. However, it has been found in practice that if electronic products are used at low temperatures, activating the self-balancing function may cause a voltage gap between each battery cells to be too large, eventually causing the battery to enter a permanent fail state.

### SUMMARY

The application provides a battery module, which includes a battery cell pack and a control circuit. The battery cell pack includes a plurality of battery cells connected in series. The control circuit is connected to the battery cells. The control circuit detects an internal temperature of the battery module and determines whether the internal temperature of the battery module is greater than a temperature threshold value. When the internal temperature is greater than the temperature threshold value, the control circuit turns on a self-balancing function.

The application also provides a battery protection method adapted for the battery module. The battery cell pack included in the battery module includes a plurality of battery cells connected in series. The method includes the following steps: detecting an internal temperature of the battery module and determining whether the internal temperature of the battery module is greater than a temperature threshold value; and turning on a self-balancing function when the internal temperature is greater than the temperature threshold value.

Based on the above, the battery module and the battery protection method thereof in the application take into account the characteristics of the battery cells to avoid activating the self-balancing function at low temperatures. In this way, the battery can be prevented from entering the permanent fail state.

In order to make the above-mentioned features and advantages of this case more obvious and easier to understand, embodiments are given below and explained in detail with the accompanying drawings.

### BRIEF DESCRIPTION OF THE DRAWINGS

FIG. 1 is a block diagram of a battery module according to an embodiment of the application.

FIG. 2 is a schematic circuit diagram of a discharge circuit according to an embodiment of the application.

FIG. 3 is a flow chart of a battery protection method according to an embodiment of the application.

FIG. 4 is a flow chart of a battery protection method according to an embodiment of the application.

### DESCRIPTION OF THE EMBODIMENTS

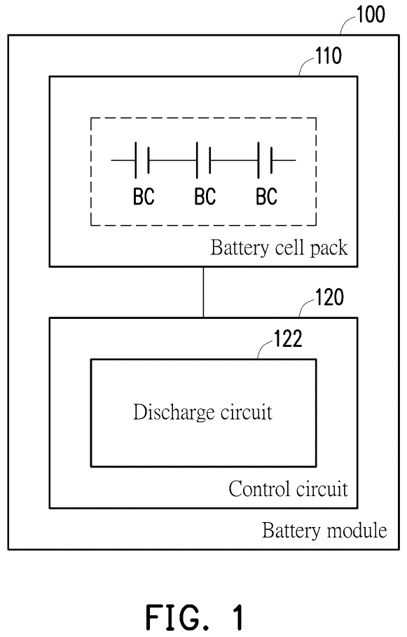

Referring to FIG. 1, the battery module 100 of the embodiment is suitable for a handheld electronic product such as a notebook computer, a mobile phone, a digital camera, and a tablet computer. The battery module 100 includes a battery cell pack 110 and a control circuit 120.

the battery cell pack 110 includes a plurality of battery cells (battery cell unit) BC connected in series. The control circuit 120 is, for example, a battery gauge IC or a microcontroller. The control circuit 120 is coupled to the battery cell pack 110, which can detect the internal temperature of the battery module 100 through, for example, a temperature sensor disposed inside the battery module 100. In addition, the control circuit 120 can also detect the voltage of each battery cells BC and calculate the stored power of the battery module 100 and each battery cells BC.

The control circuit 120 includes a discharge circuit 122 coupled to the battery cells BC, which can be used to provide a self-balancing function. When the self-balancing function is turned on, the control circuit 120 can establish one or more discharge loops through the discharge circuit 122 to balance the voltage between each battery cells BC.

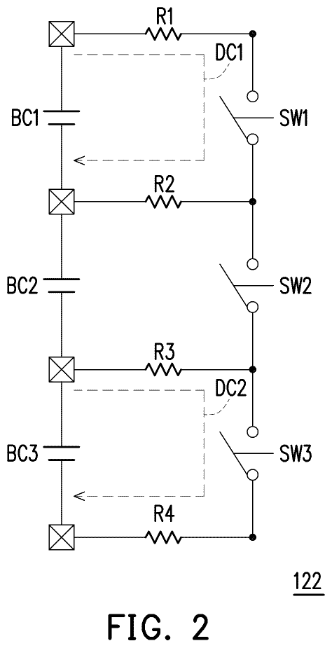

The discharge circuit 122 includes a plurality of switches connected in series and a plurality of resistors respectively coupled between one end of the corresponding switch and one end of the corresponding battery cell BC. For example, the battery cells BC of the battery cell pack 110 include a first battery cell BC1, a second battery cell BC2 and a third battery cell BC3 connected in series. Referring to FIG. 2, in the discharge circuit 122, a first resistor R1 is coupled between the first terminal of the first battery cell BC1 and the first terminal of a first switch SW1. A second resistor R2 is coupled between the first terminal of the second battery cell BC2 and the first terminal of a second switch SW2. A third resistor R3 is coupled between the first terminal of the third battery cell BC3 and the first terminal of a third switch SW3. A fourth resistor R4 is coupled between the second terminal of the third battery cell BC3 and the second terminal of the third switch SW3. In the embodiment, the first switch SW1 to the third switch SW3 are respectively controlled to be turned on or off by control signals from the control circuit 120.

During the period of balancing the voltage between each battery cells BC in the first battery cell BC1 to the third battery cell BC3, the control circuit 120 may cause one or more conductions of the first switch SW1 to the third switch SW3 to establish one or more discharge loops. For example, when the self-balancing function is turned on, the control circuit 120 can periodically detect the voltages of the first battery cell BC1 to the third battery cell BC3. If the voltage of the first battery cell BC1 is the highest and higher than the voltage of the battery cell with the lowest voltage reaches a predetermined voltage (for example, 5 mV), then the control circuit 120 can turn on the first switch SW1 to establish a discharge loop DC1 composed of the first resistor R1, the first switch SW1 and the second resistor R2, so that the first battery cell BC1 can perform self-discharge. If the voltage of the third battery cell BC3 is the highest and higher than the voltage of the battery cell with the lowest voltage reaches a predetermined voltage (for example, 5 mV), then the control circuit 120 can turn on the third switch SW3 to establish a discharge loop DC2 composed of the third resistor R3, the third switch SW3 and the fourth resistor R4, so that the third battery cell BC3 can perform self-discharge, and so on. Moreover, the control circuit 120 can turn on the corresponding switches sequentially or simultaneously according to the voltage of each battery cells BC from the first battery cell BC1 to the third battery cell BC3, thereby balancing the voltage between each battery cells in the first battery cell BC1 to the third battery cell BC3.

Generally, due to the characteristics of battery cells at low temperatures (such as minus 5 degrees to minus 10 degrees Celsius), the electrolyte will become very viscous, causing the impedance value of the battery cells to increase. The lower the temperature, the more viscous the electrolyte becomes. Therefore, if the internal temperature of the battery module 100 is below a specific temperature threshold value (for example, minus 5 degrees Celsius), when the control circuit 120 performs the self-balancing operation, the voltage of the originally higher voltage battery cell BC may instantly become very low due to the large impedance value during self-discharge. As a result, other battery cells also need to perform self-discharge actions, but when other battery cells self-discharge, the voltage will instantly become very low due to the large impedance value. Such continuous repetition may eventually cause the voltage difference between each battery cells BC to be too large, eventually causing the battery module 100 to enter the permanent fail state.

Therefore, in the embodiment of the present invention, the battery module 100 needs to be restricted to a certain temperature range before the self-balancing function is allowed to be turned on. When the internal temperature of the battery module 100 is below the specific temperature threshold value, the self-balancing function needs to be turned off to avoid permanent failure.

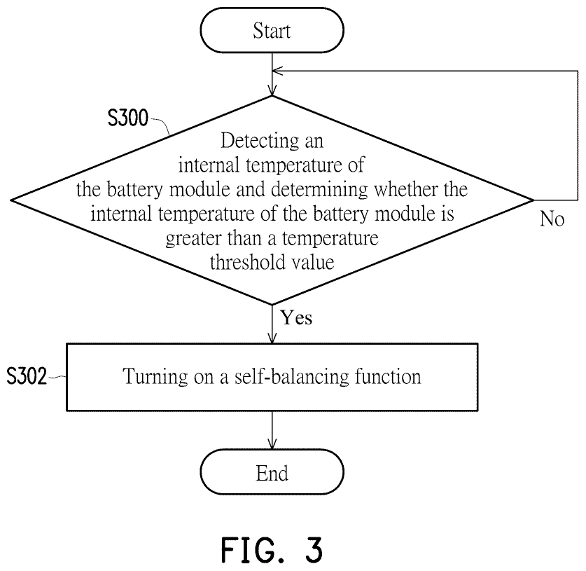

In details, the control circuit 120 can load the stored firmware to execute the battery protection method of the present invention. The following is an example to illustrate the detailed steps of the battery protection method of the present invention. Referring to FIG. 1 and FIG. 3 at the same time, the battery protection method of the embodiment can be applied to the battery module 100 of FIG. 1, and the steps are described as follows:

First, in step S300, the control circuit 120 detects an internal temperature of the battery module 100 and determines whether the internal temperature of the battery module 100 is greater than a temperature threshold value. The temperature threshold value of the embodiment is, for example, minus 5 degrees Celsius, but the invention is not limited thereto. Those skilled in the art can make appropriate adjustments based on actual needs and with reference to the teachings of the embodiment.

When the internal temperature of the battery module 100 is not greater than the temperature threshold value, the control circuit 120 may keep the self-balancing function turned off and continue to monitor the internal temperature of the battery module 100 until the internal temperature of the battery module 100 is greater than the temperature threshold.

When the internal temperature of the battery module 100 is greater than the temperature threshold value, in step S302, the control circuit 120 turns on the self-balancing function. Specifically, regardless of the stored power of the battery module 100, once the internal temperature of the battery module 100 is greater than the temperature threshold value, the control circuit 120 can turn on the self-balancing function. In other words, in the entire range of the relative state of charge (RSOC) of the battery module 100 from 0% to 100%, when the internal temperature of the battery module 100 is greater than the temperature threshold value, the control circuit 120 can turn on the self-balancing function, thereby increasing the service life of each battery cells. The implementation details of the self-balancing function can be referred to the embodiments of FIG. 1 and FIG. 2, and will not be described again here.

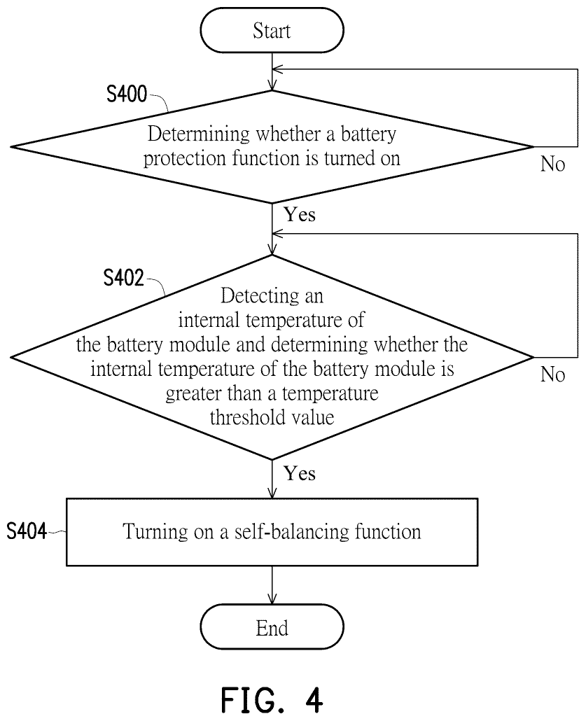

The following is another example to illustrate the detailed steps of the battery protection method of the present invention. Referring to FIG. 1 and FIG. 4 at the same time, the battery protection method of the embodiment can be applied to the battery module 100 of FIG. 1, and the steps are described as follows:

First, in step S400, the control circuit 120 determines whether a battery protection function is turned on. The battery protection function is mainly for the battery protection method that turns on a self-balancing function described in the present invention. For example, the control circuit 120 can determine whether the battery protection function is enabled according to the settings in the firmware. When the battery protection function is not turned on, the control circuit 120 will continue to determine whether the battery protection function is turned on until the battery protection function is turned on.

When the battery protection function is turned on, in step S402, the control circuit 120 detects the internal temperature of the battery module 100 and determines whether the internal temperature of the battery module 100 is greater than a temperature threshold value. When the internal temperature of the battery module 100 is not greater than the temperature threshold value, the control circuit 120 will continue to monitor the internal temperature of the battery module 100 until the internal temperature of the battery module 100 is greater than the temperature threshold value.

When the internal temperature of the battery module 100 is greater than the temperature threshold value, in step S404, the control circuit 120 turns on a self-balancing function. Steps S402 and S404 are the same as or similar to steps S300 and S302 in the previous embodiment, so their details will not be described again here.

In summary, the battery module and the battery protection method thereof in the present invention take into account the characteristics of the battery cells to avoid activating the self-balancing function at low temperatures. In this way, it can prevent the battery cells from self-discharging even when the impedance value is too high, thereby preventing the battery from entering the permanent fail state.

What is claimed is:

1. A battery module, comprising:
a battery cell pack, includes a plurality of battery cells connected in series; and
a control circuit, connected to the battery cells,
wherein the control circuit detects an internal temperature of the battery module and determines whether the internal temperature of the battery module is greater than a temperature threshold value, when the internal temperature is greater than the temperature threshold value, the control circuit turns on a self-balancing function.

2. The battery module according to claim 1, wherein regardless of a stored power of the battery module, when the internal temperature is greater than the temperature threshold value, the control circuit turns on the self-balancing function.

3. The battery module according to claim 1, wherein the control circuit comprises a discharge circuit, the discharge circuit is coupled to the battery cells, when the self-balancing function is turned on, the control circuit establishes one or more discharge loops through the discharge circuit to balance the voltage between each of the battery cells.

4. The battery module according to claim 3, wherein the discharge circuit comprises:
a plurality of switches connected in series; and
a plurality of resistors, respectively coupled between one end of the corresponding switch and one end of the corresponding battery cell, during a period of balancing the voltage between each of the battery cells, the control circuit turns on one or more of the switches to establish the discharge loop or the discharge loops.

5. The battery module according to claim 1, wherein the control circuit determines whether a battery protection function is turned on, when the battery protection function is turned on, the control circuit detects the internal temperature of the battery module.

6. The battery module according to claim 1, wherein the control circuit is a battery gauge IC or a microcontroller.

7. A battery protection method, adapted for a battery module, a battery cell pack included in the battery module includes a plurality of battery cells connected in series, the battery protection method comprises:
detecting an internal temperature of the battery module and determining whether the internal temperature of the battery module is greater than a temperature threshold value; and
turning on a self-balancing function when the internal temperature is greater than the temperature threshold value.

8. The battery protection method according to claim 7, wherein the step of turning on the self-balancing function comprises:
regardless of a stored power of the battery module, turning on the self-balancing function when the internal temperature is greater than the temperature threshold value.

9. The battery protection method according to claim 7, wherein the battery module further comprises a discharge circuit, the discharge circuit is coupled to the battery cells, the battery protection method further comprises:
establishing one or more discharge loops through the discharge circuit to balance the voltage between each of the battery cells when the self-balancing function is turned on.

10. The battery protection method according to claim 7, further comprises:
determining whether a battery protection function is turned on; and
detecting the internal temperature of the battery module when the battery protection function is turned on.
